(19) United States
(12) Patent Application Publication
(10) Pub. No.: US 2008/0282986 A1
(43) Pub. Date: Nov. 20, 2008

(54) Milking Machine Hose Support

(76) Inventor: Raymond Edward O'Connor, Helensville (NZ)

Correspondence Address: YOUNG & THOMPSON, 209 Madison Street, Suite 500, ALEXANDRIA, VA, 22314, US

(21) Appl. No.: 11/579,686

(22) PCT Filed: May 11, 2005
(86) PCT No.: PCT/NZ2005/000095

§ 371 Date: Nov. 6, 2006

(30) Foreign Application Priority Data
May 11, 2004 (NZ) 532858

(51) Int. Cl. A01J 7/00; A01J 5/04

(52) U.S. Cl. 119/14.13; 119/14.1

(57) ABSTRACT

A device for supporting milk and/or vacuum conduits (3, 4) for a milking machine, including a rail (10) at least one dropper (20) supported for longitudinal movement along the rail (10). The dropper (20) has a locating element (41) to position milk and/or vacuum conduits (3, 4) when in use.

### TECHNICAL FIELD OF THE INVENTION

This invention relates to a support device and has been devised particularly though not necessarily solely for use to support milk and/or vacuum conduits in a milking shed.

### BACKGROUND ART

It is usual to milk cows in a milking shed into which the cows are introduced and positioned adjacent the milking claw and teat cups so that the teat cups can be readily positioned on the udder of the cows and milking effected.

In order to achieve this efficiently and to reduce the risk of disease, such as mastitis, it is desirable to get the cows into substantial alignment. This can be difficult to achieve. The problem cannot be overcome by simply lengthening the tubes, as if the tubes are too long, they “loop” and do not milk properly and this facilitate the transfer of diseases such as mastitis.

### OBJECT OF THE INVENTION

It is therefore an object of the present invention to provide a support device and/or a milking apparatus which is obviate or minimize the foregoing disadvantages in a simple yet effective manner or which at least will provide the public with a useful choice.

### STATEMENT OF THE INVENTION

Accordingly in one aspect the invention consists in a support device comprising a rail, at least one dropper supported on the rail for longitudinal movement along the rail, the dropper or at least a substantial number of said droppers having locating means to position, in use, one or more conduits in use.

Preferably a plurality of droppers are provided.

Preferably at least a substantial number of said droppers have braking means thereon to brake but not prevent movement of said droppers along said rail.

Preferably the braking means comprises a biasing means between the rail and the dropper.

Preferably the biasing means includes a pressure member bearing on the rail and a spring between the pressure member and a part of the dropper.

Preferably the rail comprises an inverted channel member having a narrow mouth there into.

Preferably the dropper is mounted on a trolley, slider or the like, the trolley, slider or the like moving within said rail, and said dropper extending outwardly through the mouth of the channel member, the pressure member assisting in retaining the trolley, slider or like in contact with the inner surface of the rail.

Preferably the conduit supported by the support device runs to or from a milking claw.

In a further aspect the invention may broadly be said to consist in a milking apparatus having associated therewith a support device according to any one of the preceding paragraph.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

### BRIEF DESCRIPTION OF THE DRAWINGS

One preferred form of the invention will now be described with reference to the accompanying drawings in which,

FIG. 1 is a diagrammatic perspective view of part of a support device according to one preferred form of the invention,

FIG. 2 is a cross sectional view of the support device according to one preferred form of the invention,

FIG. 3 is a plan view of a locating means for use with the support device of the invention,

FIG. 4 is a diagrammatic indication showing how a support device according to the invention could be used in a low line milking shed, and

FIG. 5 is a diagrammatic indication showing how a support device according to the invention could be used in a rotary milking shed.

### BEST MODE FOR CARRYING OUT THE INVENTION

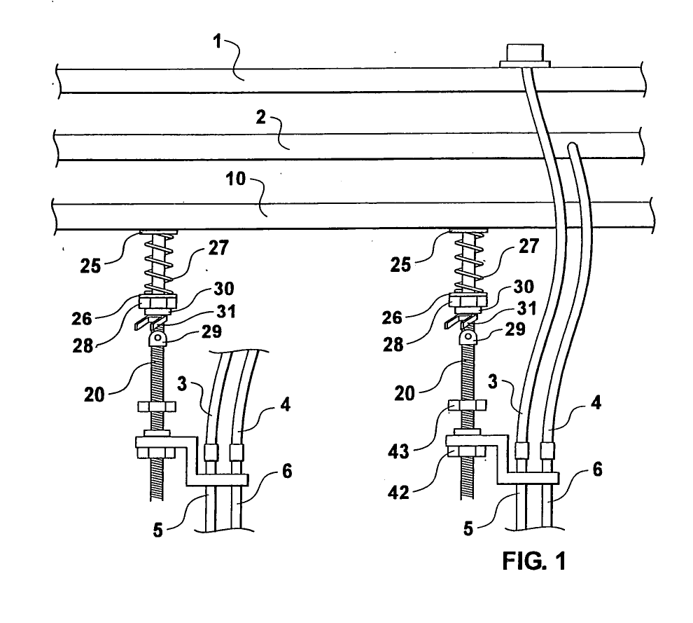

Referring to FIGS. 1 to 3 milking apparatus is provided which includes the standard milk and vacuum lines 1 and 2 from which the usual conduits 3 and 4 extend to engage conduits 5 and 6 which are engaged with the milking claw.

It may be necessary in the invention that the conduits 3 and 4 are a little longer than used in a standard milking apparatus but the required extra length should not be significant and need not be so long that the conduits 5 and 6 “loop”.

Further included is a rail 10, which is in the form of an inverted channel with a mouth 11. The mouth is narrower than the internal dimensions of the rail 10 and in particular may provide a pair of flanges 12 which extend inwardly from the sides 13 of the inverted channel so to form in effect a pair of ledges. A trolley, slider or other similar device 14 is able to move longitudinally within the channel by providing for example that wheels 17 run on flanges 12 or if some other device such as a slider is used so that the lower faces of the slider run on the flanges 12.

Extending downwardly from the trolley or slider 14 is a dropper 20, which in the preferred form of the invention is in the form of a threaded rod. The rod may be substantially rigid or could have some flexibility by being formed for example from a material such as glass reinforced plastics material.

The construction therefore is such that the dropper 20 may be moved along the rail 10 simply by manually grasping the dropper and moving it to the desired position. However it is desirable that whilst the movement should be relatively free the dropper will remain in the desired position and to this end a braking means is provided and in the preferred form this may take the form of a pair of washers 25 and 26 which are placed on the dropper 20 but are spaced apart by a biasing device such as a spring 27. The lower washer 26 may be held in position by a fixing device such as nut 28 on the dropper 20. The upper washer 25 is therefore pushed against the underside of the ledges 12 by the spring 28 which is positioned at its lower end by the washer 26 and substantially located by the nut 28. The pressure of the spring 27 also aids in keeping the wheels 17 against the inner surfaces of the flanges 12.

The dropper 20 desirably has a joint 29, preferably a universal joint, therein which enables the lower end of the dropper 20 to hang vertically in use.

A stop 30 may be provided on the dropper 20 to prevent the nut 28 being wound downwardly to an extent that desired pressure of washer 25 on the flanges 12 is lost.

If desired a herd test bracket 31 may also be provided to enable to testing milk box to be held in a convenient position.

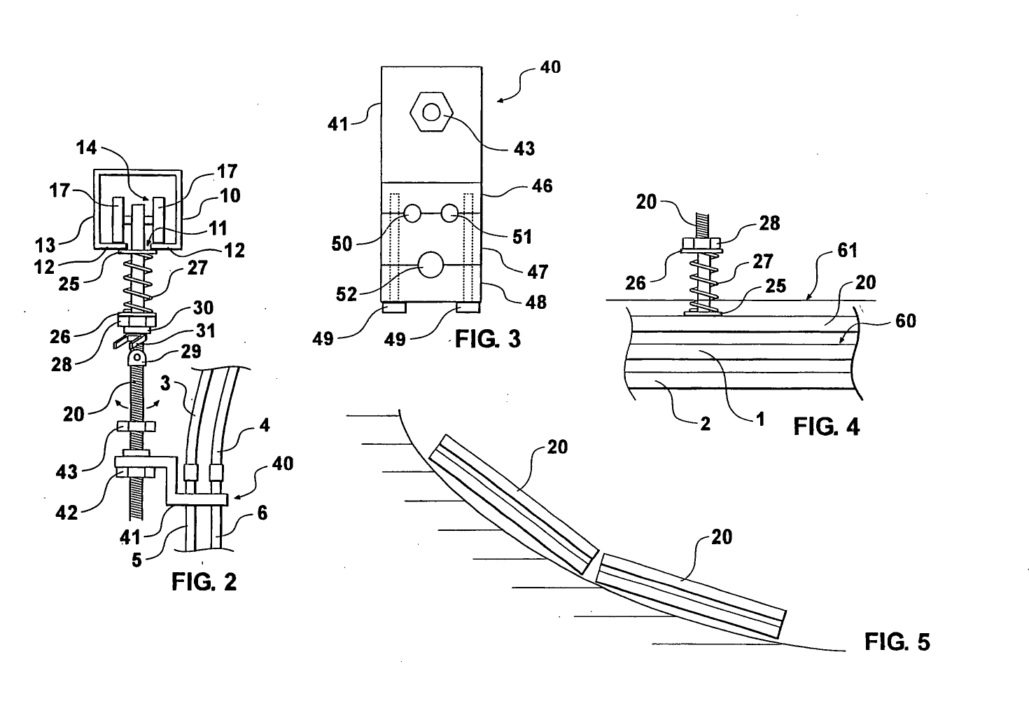

The dropper 20 also carries a holding means 40 to position the conduits 5 and 6 and therefore the conduits 3 and 4. A holding device 40 may take the form of a plate 41 which may be stepped as shown in FIG. 2 or otherwise which is held in position by a further nut 42 on the dropper 20. An upper nut 43 may be provided if desired to limit the upward movement of the device 41 into a desired range.

The conduits 5 and 6 may be positioned by forming part of a device into three parts 46, 47 and 48 held for example by bolts 49. The parts 46, 47 and 48 are shaped to provide clamping apertures 50, 51 and 52 for example as can be seen in FIG. 3. The conduits 5 and 6 pass through and are held in the apertures 50, 51 and 52.

In use the cows enter milking shed and are positioned as previously. If however the cows do not align themselves properly the dropper 20 can be grasped and pulled so that the droppers move along the rail 10 to a position which gives the effect of correct alignment of the cows. Milking can then be effected in the usual manner.

If desired a sensor such as a mechanical arm, or a reflected light sensor can be provided mounted on, for example dropper arm 20, so that a positive indication is gained as to when a cow is correctly aligned.

FIG. 4 shows in diagrammatic fashion a wall 60 with milk and vacuum lines 1 and 2 in a low line configuration, that is to say below the cows which stand on surface 61.

The rail 10 can also be positioned below surface 61 and can be invented so that the dropper 20 extends upwardly from the rail 20. If the rail 20 is placed below lines 1 and 2 or stands proud of them then the opening in the rail may again be downwards facing.

In FIG. 5 a rotary milking shed is provided and short lengths of rail 10 are mounted in a suitable position, such as overhead, around the rotary platform. Each length can have one, or more depending on size, droppers 20 positioned therein.

In each case for FIGS. 4 and 5 the use of the invention is substantially as for the use described in respect of FIGS. 1 to 3.

Thus it can be seen that at least in the preferred form of the invention a support device and/or a milking apparatus are provided in which the problem caused by the difficulty of moving cows into the correct alignment for milking is minimized or at least substantially overcome. The device has the advantage that it is easily operated and is also readily installable in existing milking sheds, as there is sufficient overhead space to install the rail. The rail is also able to be made from readily available parts and materials which also is an advantage. I have found that having the cows correctly aligned enables the cows to be more easily “milked out” at each milking. I believe that this allows a significant reduction in the incidence of mastitis.

Throughout the description and claims of this specification the word “comprise” and variations of that word, such as “comprises” and “comprising”, are not intended to exclude other additives, components, integers or steps.

1. A support device comprising a rail, at least one dropper supported on a rail for longitudinal movement along the rail, the dropper or at least a substantial number of said droppers having locating means to position, in use, one or more conduits in use.

2. A support device as claimed in claim 1 wherein a plurality of droppers are provided.

3. A support device as claimed in claim 2 wherein at least a substantial number of said droppers have braking means thereon to brake but not prevent movement of said droppers along said rail.

4. A support device as claimed in claim 3 wherein the braking means comprises a biasing means between the rail and the dropper.

5. A support device as claimed in claim 4 wherein the biasing means includes a pressure member bearing on the rail and a spring between the pressure member and a part of the dropper.

6. A support device as claimed in claim 1 wherein the rail comprises a channel member having a narrow mouth there into.

7. A support device as claimed in claim 6 wherein the dropper is mounted on a trolley, slider or the like, the troller, slider or the like moving within said rail, and said dropper extending outwardly through the mouth of the channel member, the pressure member assisting in retaining the trolley, slider or like in contact with the inner surface of the rail.

8. A support device as claimed in either claim 7 wherein the channel member is inverted.

9. A support device as claimed in claim 1 wherein the conduit supported by the support device runs to or from a milking claw.

10. A milking apparatus having associated therewith a support device according to claim 1.

11. A support device as claimed in claim 2 wherein the rail comprises a channel member having a narrow mouth there into.

12. A support device as claimed in claim 3 wherein the rail comprises a channel member having a narrow mouth there into.

13. A support device as claimed in claim 4 wherein the rail comprises a channel member having a narrow mouth there into.

14. A support device as claimed in claim 5 wherein the rail comprises a channel member having a narrow mouth there into.

15. A support device as claimed in claim 2 wherein the conduit supported by the support device runs to or from a milking claw.

16. A support device as claimed in claim 3 wherein the conduit supported by the support device runs to or from a milking claw.

17. A support device as claimed in claim 4 wherein the conduit supported by the support device runs to or from a milking claw.

18. A support device as claimed in claim 5 wherein the conduit supported by the support device runs to or from a milking claw.

19. A support device as claimed in claim 6 wherein the conduit supported by the support device runs to or from a milking claw.

20. A support device as claimed in claim 7 wherein the conduit supported by the support device runs to or from a milking claw.
